(19) United States
(12) Patent Application Publication
(10) Pub. No.: US 2007/0248426 A1
(43) Pub. Date: Oct. 25, 2007

(54) Device for Fixating a Portable Drilling Machine in Guide Holes in a Template

(76) Inventor: Bjorn Pettersson, Järfalla (SE)

Correspondence Address: SCHWEGMAN, LUNDBERG & WOESSNER, P.A., P.O. BOX 2938, MINNEAPOLIS, MN, 55402, US

(21) Appl. No.: 11/629,059

(22) PCT Filed: Jun. 7, 2005
(86) PCT No.: PCT/SE05/00855

§ 371 Date: Dec. 8, 2006

Related U.S. Application Data
(60) Provisional application No. 60/521,638, filed on Jun. 9, 2004.

(51) Int. Cl. B23B 39/26

(52) U.S. Cl. 408/3

(57) ABSTRACT

A device (12) for detachably fixating a portable drilling machine to guide holes in a template includes a sleeve (20) having a substantially cylindrical portion to be inserted into a guide hole, and an expansion member (26) with a lever (34) extending radially from an axial portion thereof. The expansion member (26) is pivotally mounted in a recess (36) in the sleeve about a pivot center (38). The sleeve has two axial, circumferentially spaced contact sections (24), whereas the expansion member (26) has a third axial contact section (32) for engaging the wall surface of the guide hole. The expansion member (26) is biased by a spring (44), via the lever, towards a locking position in which all three contact sections (24, 32) may engage the wall surface of the guide hole so as to fixate the drilling machine to the template.

### BACKGROUND OF THE INVENTION

1. Field of the invention

The present invention relates to a device for detachably fixating a portable drilling machine in guide holes in a template which is attached to a workpiece in which holes are to be machined at predetermined locations corresponding to the location of the guide holes. Each guide hole may constitute a central hole of a guide bushing inserted in and secured to a hole in the template.

2. Description of related art

For example, WO 94/17944, WO 01/15870, WO 02/102535, and U.S. Pat. No. 5,088,171 disclose previously known devices for fixation of portable drilling machines to a template attached to a workpiece in which holes are to be produced. These devices utilize a non-expandable fixation or guide sleeve or pairs of fixation screws or posts extending from either side of a respective guide hole in the template.

### SUMMARY OF THE INVENTION

An object of the present invention is to provide a fixation device configured to be mounted -to the front end of a portable drilling machine and adapted to be fixated in a guide hole in the template, or, more preferably, in a hole of a guide bushing inserted and fixated in a hole in the template, such that the drilling machine, regardless of the rotary position thereof relative to the guide hole, can be simply and quickly attached to the template and securely fixated during the machining of a hole in the workpiece. To this end, the fixation device of the present invention comprises a sleeve configured to be attached to a front end of the drilling machine and having a substantially cylindrical portion to be inserted into a guide hole. The cylindrical portion is provided with two external, axially extending, circumferentially spaced raised areas forming contact sections of the sleeve for engaging the surface of the guide hole, and with a recess in a peripheral section of the cylindrical portion. The fixation device further includes an expansion member having, on an outer peripheral surface of an axial portion thereof, an axially extending, third raised contact section and a lever extending radially from the axial portion. The expansion member is pivotally mounted in the recess in the peripheral section of the cylindrical portion of the sleeve and is biased by a spring, via the lever, towards a locking position in which all raised contact sections may engage the surface of the guide hole so as to fixate the drilling machine to the template, whereas the device is releasable from the template by exerting on the lever a force acting against and exceeding the force of the biasing spring. Thus, when turning the lever to the locking position, the raised contact areas of the fixation device will be displaced radially outwardly to accomplish a clamping action that safely holds the drilling machine attached to the template.

The fixation device of the invention will be further explained in the following detailed description with reference to the accompanying drawings.

### BRIEF DESCRIPTION OF THE DRAWINGS

FIG. 1 is a perspective view of an orbital drilling machine equipped with a fixation device of the present invention;

FIG. 2 is a perspective view of a sleeve component of the fixation device;

FIG. 3 is a plan view, as seen from below, of the fixation device of the invention;

FIGS. 4 and 5 are perspective views of the fixation device of the invention; and

FIG. 6 is a perspective view of the expansion member of the fixation device of the invention.

### DESCRIPTION OF A PREFERRED EMBODIMENT

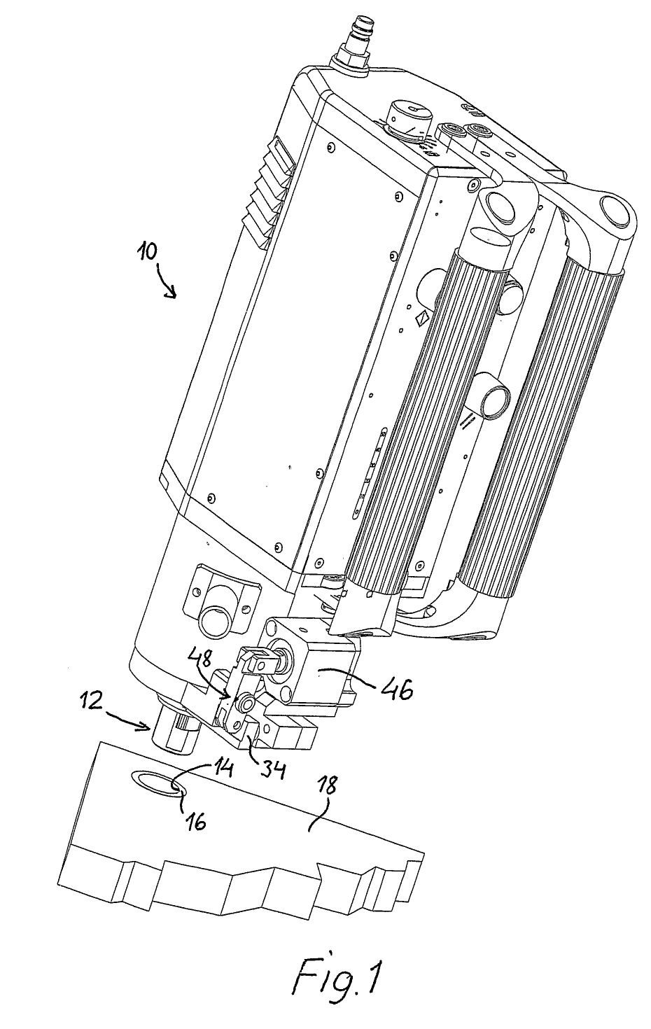

FIG. 1 discloses an orbital drilling machine 10 equipped with a fixation device 12 of the present invention for fixating the machine 10 in a guide hole 14 of a bushing 16 inserted and secured in a hole in a template 18. The template 18 is attached to an adjacent work piece (not shown) in which holes are to be produced by a cutting tool of the drilling machine 10. Although portable drilling machines in general can be detachably secured to a template by means of the fixation device of the present invention, the latter is in particular suitable for use with an orbital drilling machine which is capable of forming holes of various dimensions and configurations with only one single cutting tool.

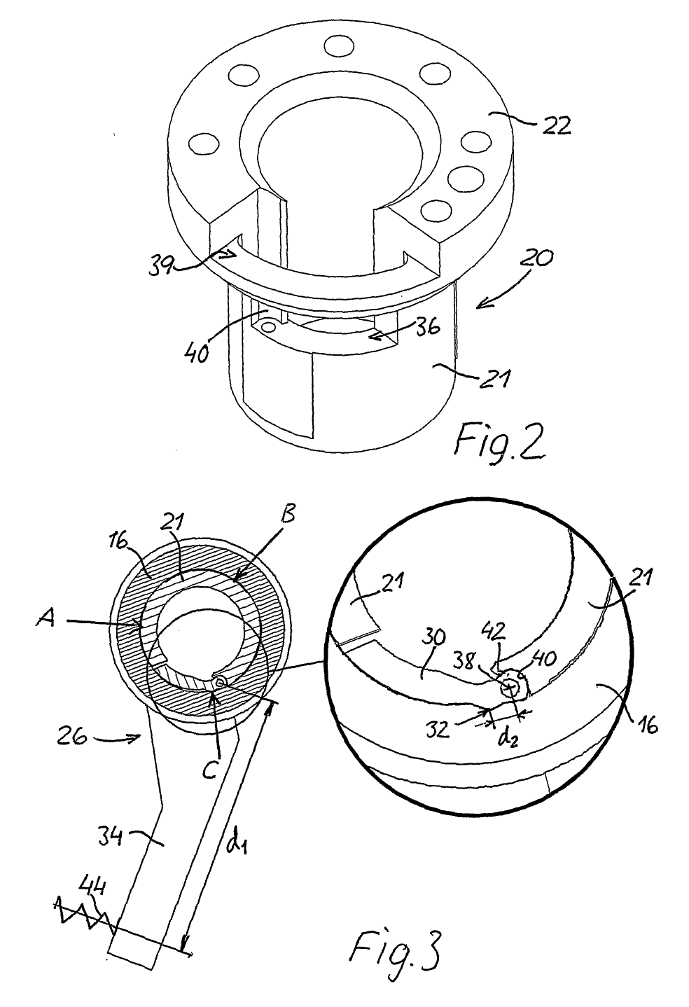

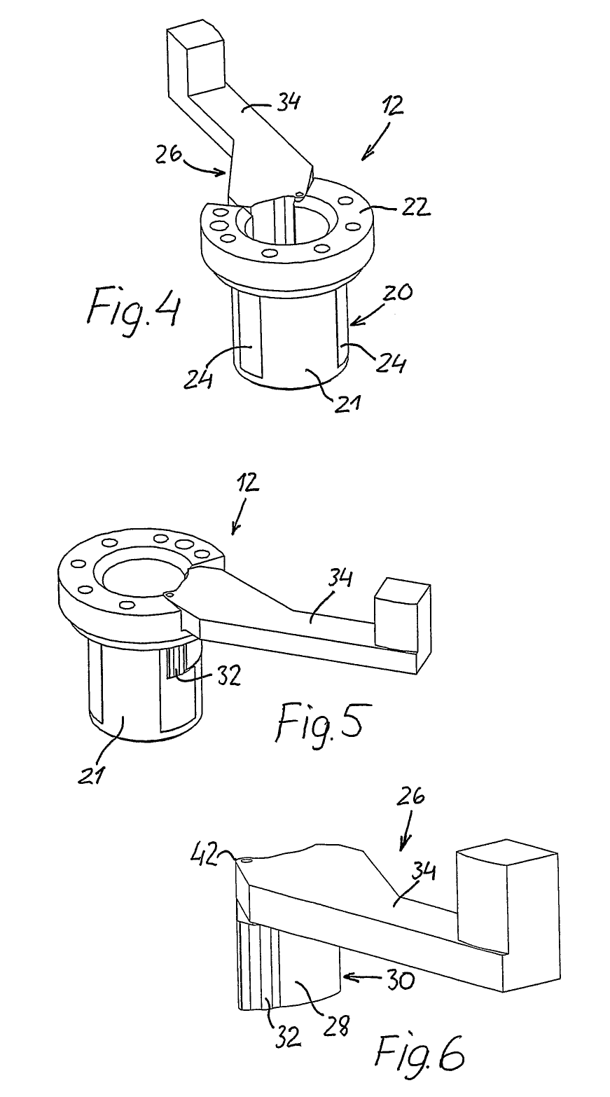

As shown in FIG. 2, the fixation device comprises a sleeve 20 having a cylindrical portion 21 configured to be inserted into the guide hole 14 of the bushing 16, and a collar 22 for attaching the sleeve 20 to the drilling machine 10. The cylindrical portion 21 is provided with two axial, circumferentially spaced raised areas which form contact sections 24 (see FIG. 4) of the sleeve 20 for engaging the wall surface of the guide hole 14 of the bushing 16.

As seen in FIGS. 3-6, the fixation device further comprises an expansion member 26 having, on an outer peripheral surface 28 of an axial portion 30 thereof (FIG. 6), a third axial, raised contact section 32, and a lever 34 extending radially from said axial portion 30. The expansion member 26 is pivotally mounted in a recess 36 in a peripheral section of the cylindrical portion 21 about a pivot center 38. The inner portion of the lever 34 is received in a cut-out 39 in the collar 22, adjacent to the recess 36. As seen in the enlarged encircled area of FIG. 3, a concave surface 40 of the cylindrical portion 21 directly engages and supports a corresponding convex surface 42 of the expansion member 26, so that the cylindrical portion 21, via the engaging curved surfaces 40, 42, takes up forces generated when pivoting the lever 34 to a locking position. Thus, the third contact section 32 is moveable radially outwardly when pivoting the lever 34 in a clockwise direction in FIGS. 4 and 5, and radially inwardly when pivoting the lever 34 in a counter clockwise direction.

A compression spring 44, schematically illustrated in FIG. 3, is biasing the lever 34 towards a rotary position in which the third contact section 32 of the lever 34 is displaced radially outwardly to accomplish a clamping action together with the two contact sections 24 (see the three arrows A, B and C) in order to fixate the sleeve 20 in the guide hole 14 of the bushing 16. As seen in the enlarged encircled area of FIG. 3, the arm or distance d₁ between the pivot center 38 and the apex of the third raised contact section 32 is very short in comparison with the arm or distance d₂ between the pivot center 32 and the point of action of the compression spring 44 on the lever 34. This means that the third contact section 32, together with the two other contact sections 24, will exert a high pressure against the surface of the guide hole 14 of the bushing 16 due to the torque action generated by the spring 44, thereby ensuring a safe fastening and locking of the sleeve 20 and the drilling machine 10 attached thereto, in the guide bushing 16 during the machining of a hole in the workpiece. In order to unlock the fixation device 12 and release the drilling machine 10 from the template 18, a pneumatic cylinder 46 (FIG. 1) integrated with the drilling machine 10 may act on the lever 34 against the action of the compression spring 34 via a link mechanism 48.

1. A device 9 for detachably fixating a portable drilling machine to guide holes in a template 9 which is attachable to a workpiece in which holes are to be machined, comprising
a sleeve configured to be attached to a front end of the drilling machine and having a substantially cylindrical portion to be inserted into a guide hole, wherein the cylindrical portion includes two external, axially extending, circumferentially spaced, raised contact sections for engaging a wall surface of the guide hole wherein the cylindrical portion includes a recess in a peripheral section of the cylindrical portion
an expansion member 3 having, on an outer peripheral surface of an axial portion thereof, an axially extending, third raised contact section and
a lever extending radially from said axial portion the expansion member being pivotally mounted in the recess in the peripheral section of the cylindrical portion of the sleeve and biased by a spring, via the lever, towards a locking position in which all raised contact sections may engage the surface of the guide hole so as to fixate the drilling machine to the template, whereas the device is releasable from the template by exerting on the lever a force acting against and exceeding the force of the biasing spring.

2. The device of claim 1, wherein the expansion member is pivotally supported in the sleeve about a pivot center by means of a convex portion of the expansion member engaging a corresponding concave portion in the sleeve.

3. The device of claim 1, wherein the lever is biased by a compression spring towards the locking position.

4. The device of claim 1, wherein the sleeve includes a collar for attaching it to the drilling machine.

5. The device of claim 4, wherein the collar includes a cut-out to permit limited pivotal movement of the level.

6. The device of claim 2, wherein the lever is biased by a compression spring towards the locking position.

7. The device of claim 6, wherein the sleeve includes a collar for attaching to the drilling machine.

8. The device of claim 7, wherein the collar includes a cut-out to permit limited pivotal movement of the level.

9. The device of claim 3, wherein the sleeve includes a collar for attaching to the drilling machine.

10. The device of claim 9, wherein the collar includes a cut-out to permit limited pivotal movement of the level.
